(19) United States
(12) Patent Application Publication
(10) Pub. No.: US 2010/0007147 A1
(43) Pub. Date: Jan. 14, 2010

(54) APPARATUS FOR CONVERTING WAVE MOTION INTO MECHANICAL ENERGY

(76) Inventor: David Francis Coulson, Wooler (GB)

Correspondence Address: Zilka-Kotab, PC, P.O. BOX 721120, SAN JOSE, CA, 95172-1120, US

(21) Appl. No.: 12/305,537

(22) PCT Filed: Jun. 25, 2007
(86) PCT No.: PCT/GB2007/002359

§ 371 Date: Dec. 18, 2008

(30) Foreign Application Priority Data
Jun. 27, 2006 (GB) 0612675.9

(51) Int. Cl. F03B 13/24

(52) U.S. Cl. 290/53

(57) ABSTRACT

An apparatus (2) is disclosed for generating relative motion between the apparatus and the surface of the sea on which the apparatus floats. The apparatus comprises a body (6) adapted to float on the water surface and which defines an annular chamber (28) above the water surface and in communication with said water surface, wherein the chamber is able to expand or contract as the height of the water surface varies as a result of wave motion, to enable movement of the body relative to the water surface.

The present invention relates to apparatus for generating motion relative to a water surface on which the apparatus floats, and relates particularly, but not exclusively, to apparatus for generating relative motion from wave motion in order to generate electrical power.

Apparatus for generating electrical power from wave motion is known in which the motion of sea water relative to the apparatus drives a turbine or other means of power generation. However, such apparatus suffers from the drawback that some form of anchorage must usually be used in order to use the relative motion for power generation. For example, the apparatus may be tethered to a fixed, or relatively fixed, point, such as the shore or the seabed.

Preferred embodiments of the present invention seek to overcome the above disadvantages of the prior art.

According to the present invention, there is provided an apparatus for generating relative motion between the apparatus and a water surface on which the apparatus floats, the apparatus comprising:

a body adapted to float on the water surface and define at least one first chamber above the water surface and in communication with said water surface, wherein at least one said first chamber is adapted to expand or contract as the height of the water surface varies as a result of wave motion, to enable movement of the body relative to the water surface. By providing at least one first chamber above and open to the water surface, wherein at least one said first chamber is able to expand or contract as the height of the water surface varies as a result of wave motion, to enable movement of the body relative to the water surface, this provides the advantage of enabling movement of the body relative to the water surface without the use of anchorage to generate power from the relative motion. This relative movement can in turn be used to generate electrical power. For example, the relative motion can cause air to be expelled out of and drawn into an aperture in the body, which can be used to drive a two-way turbine to generate electricity.

In a preferred embodiment, the body is adapted to define at least one second chamber communicating with said water surface and with the atmosphere, such that motion of the body relative to the water surface causes air to enter or exit from said second chamber.

The apparatus may further comprise at least one aperture in at least one said second chamber.

This provides the advantage of enabling air passing through the aperture to drive a turbine to provide electrical power.

The apparatus may further comprise at least one turbine adapted to be driven by air entering and/or exiting from at least one said second chamber.

At least one said second chamber may be compressible in a horizontal direction when the body floats on the water surface.

This provides the advantage of enabling at least part of the body to be compressed by means of lateral components of a wave.

The body may define at least one third chamber for accommodating water.

This provides the advantage of enabling water, derived from the body of water on which the apparatus floats, to be used as reactive ballast.

At least one said third chamber may be so shaped as to focus sunlight when filled with water.

This provides the advantage of enabling the sunlight to be focused onto a solar panel to generate further electrical power.

At least part of said body may be formed from flexible material.

This provides the advantage of enabling at least part of the volume of the said body to be varied by means of lateral, as well as vertical, force components of a wave, which increases the amount of energy which can be derived from a wave.

The apparatus may further comprise attachment means for enabling attachment of the apparatus to a further said apparatus.

This provides the advantage of enabling a plurality of such apparatus to be attached together to form an array on the water surface.

At least one said first chamber may have at least one flexible wall to enable said first chamber to expand or contract as the height of the water surface varies.

Said expansion or contraction may be assisted by linking the motion of the device versus the water surface to a flexible part of at least one said first chamber.

A preferred embodiment of the invention will now be described, by way of example only and not in any limitative sense, with reference to the accompanying drawings, in which:

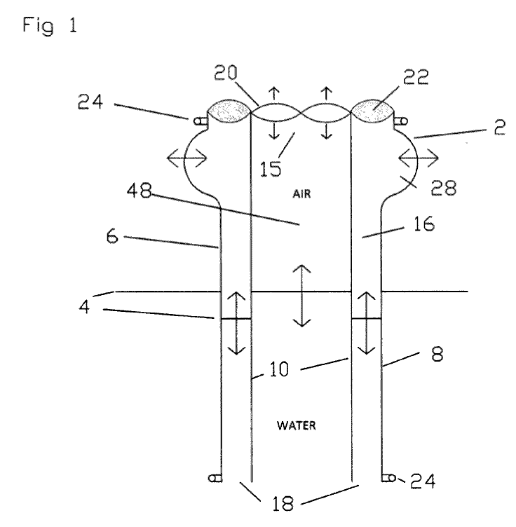

FIG. 1 is a schematic elevational cross section view of an electrical power generating apparatus embodying the present invention;

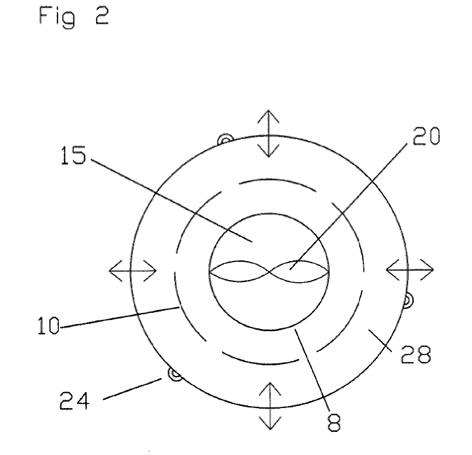

FIG. 2 is a schematic plan view of the apparatus of FIG. 1;

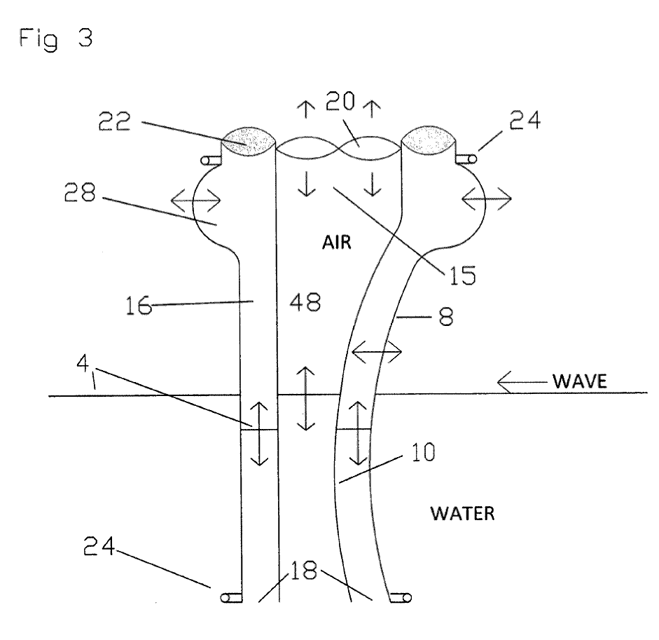

FIG. 3 is a schematic representation of how the apparatus of FIG. 1 can be distorted by the horizontal (surge) component of a wave;

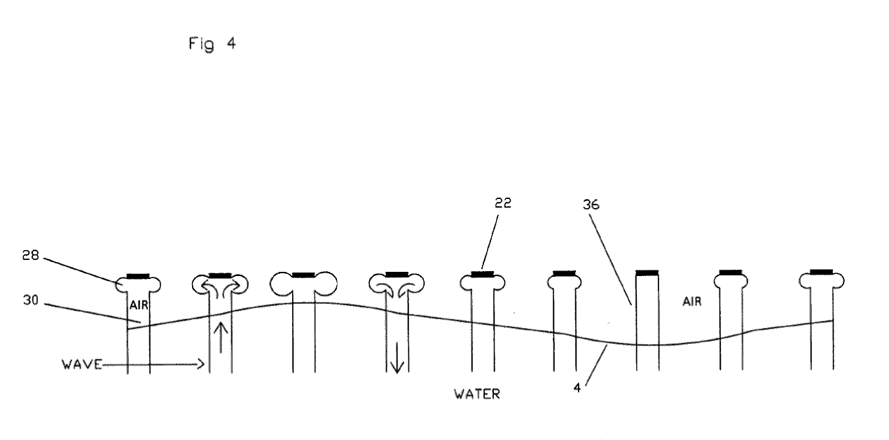

FIG. 4 is a schematic representation of the process of operation of an apparatus of a second embodiment of the present invention; and

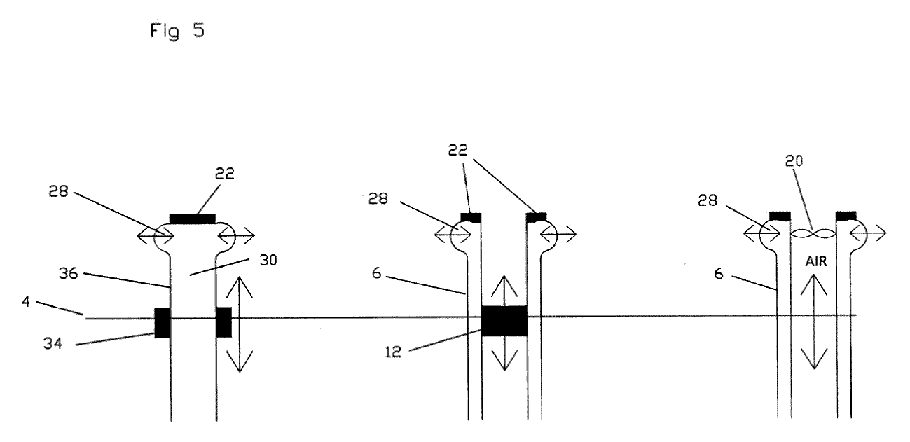

FIG. 5 is a schematic representation of three alternative embodiments of the present invention.

Referring to FIGS. 1 and 2, an apparatus 2 for generating electrical power floats on a surface 4 of a body of water such as the sea. The apparatus 2 has a body 6 defining an outer cylinder 8 of semi-flexible material surrounding and rigidly separated by means of suitable spacers (not shown) from a semi-flexible inner cylindrical wall 10.

An annular air space 16 is defined between cylindrical walls 8, 10 and is open to the sea at its lower end 18. The upper part of the body 6 has an aperture 15 in which a two-way turbine 20 is arranged, and chambers 22 containing seawater provide reactive mass or ballast to assist in operation of the apparatus. The apparatus 2 can be connected to other similar apparatus by means of mooring points 24. The upper part of the annular air space 16 is formed from a flexible material such as rubber, and defines an annular chamber 28, which can expand and contract as the pressure of air trapped in the air space 16 varies.

The operation of the apparatus 2 will now be described.

When the apparatus 2 is floating on the surface 4 of the sea, as the water level 4 begins to rise in annular air space 16 because of wave motion, the pressure of the air in space 16 increases. As a result, some of the air is forced into annular chamber 28, causing it to expand, thereby reducing the amount of air in annular space 16 and causing the whole body 6 to sink in relation to the water surface. This sinking of body 6 causes some of the air in space 48 at the upper part of the body 6 to be forced out of aperture 15 to drive turbine 20 and generate electrical power.

As the water level 4 falls because of wave motion, the pressure in air chamber 16 reduces, as a result of which the chamber 28 contracts and expels air into the annular space 16. At the same time, the increasing amount of air in annular space 16 causes the body 6 to rise relative to the water surface 4, which movement causes air to be drawn in through aperture 15 into the space 48 to drive two-way turbine 20 in the opposite direction and further generate electrical power.

The said relative motion between body 6 and water level 4 can be utilised to assist expansion and contraction of chamber 28 by, for example, a very simple mechanical or other linkage between a float on surface 4 and the flexible part of chamber 28.

Referring to FIG. 3, cylinder walls 8 and 10 are semi-flexible so that they will move under pressure from the horizontal force component of a wave, thus further reducing space 48 as a wave rises and propelling more air through turbine 20, thereby generating more power. Similarly, more air will be sucked through turbine 20 as a wave falls.

Referring to FIG. 4, this shows the representative sequence of airflows between a cylindrical (rather than annular) first chamber 30 and attached second chamber 28, demonstrating that the top of body 36 can remain more or less at the same datum level whilst a wave rises and falls alongside it, or within an annular body

Referring to FIG. 5, this shows power conversion via an oscillating water column apparatus and turbine 20 as previously described, and two of many possible alternative methods: an electromagnetic apparatus utilising the relative motion between the body 6 and a float on the sea surface 4 connected to the body via the electromagnetic apparatus; said float being either 12 inside body 6, or 34 outside body 36 containing cylindrical first chamber 30.

It will be appreciated by persons skilled in the art that the above embodiment has been described by way of example only, and not in any limitative sense, and that various alterations and modifications are possible without departure from the scope of the invention as defined by the appended claims. For example, instead of having a flexible wall to enable it to expand or contract, the annular chamber 28 may have a moveable rigid wall.

1. An apparatus for generating relative motion between the apparatus and a water surface on which the apparatus floats, the apparatus comprising:
a body adapted to float on the water surface and define at least one first chamber above the water surface and in communication with said water surface, wherein at least one said first chamber is adapted to expand or contract as the height of the water surface varies as a result of wave motion, to enable movement of the body relative to the water surface.

2. An apparatus according to claim 1, wherein the body is adapted to define at least one second chamber communicating with said water surface and with the atmosphere, such that motion of the body relative to the water surface causes air to enter or exit from said second chamber.

3. An apparatus according to claim 2, further comprising at least one aperture in at least one said second chamber.

4. An apparatus according to claim 2, further comprising at least one turbine adapted to be driven by air entering and/or exiting from at least one said second chamber.

5. An apparatus according to claim 2, wherein at least one said second chamber is compressible in a horizontal direction when the body floats on the water surface.

6. An apparatus according to claim 1, wherein the body defines at least one third chamber for accommodating water.

7. An apparatus according to claim 6, wherein at least one said third chamber is so shaped as to focus sunlight when filled with water.

8. An apparatus according to claim 1, wherein at least part of said body is formed from flexible material.

9. An apparatus according to claim 1, further comprising at least one attachment device for enabling attachment of the apparatus to a further said apparatus.

10. An apparatus according to claim 1, wherein at least one said first chamber has at least one flexible wall to enable said first chamber to expand or contract as the height of the water surface varies.

11. An apparatus according to claim 10, wherein said expansion or contraction may be assisted by linking the motion of the device versus the water surface to a flexible part of at least one said first chamber.
